(19) United States
(12) Patent Application Publication
(10) Pub. No.: US 2009/0136787 A1
(43) Pub. Date: May 28, 2009

(54) FLUORINATION OF A POROUS HYDROCARBON-BASED POLYMER FOR USE AS COMPOSITE MEMBRANE

(76) Inventors: Paul D. Kozak, Surrey (CA); Cindy Mah, Vancouver (CA); Scott J. McDermid, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/365,843

(22) Filed: Feb. 4, 2009

Related U.S. Application Data
(62) Division of application No. 11/686,646, filed on Mar. 15, 2007.
(60) Provisional application No. 60/782,833, filed on Mar. 16, 2006.
(60) Provisional application No. 60/809,506, filed on May 31, 2006.

(51) Int. Cl. H01M 8/00; C08J 5/20

(52) U.S. Cl. 429/12; 521/27

(57) ABSTRACT

Fluorination of a porous hydrocarbon-based polymer for use as a composite membrane and, more particularly, for use as a composite proton exchange membrane for a fuel cell. The composite membrane is formed by fluorination of the porous hydrocarbon-based polymer to yield a selectively fluorinated polymer, which is then loaded with an ionomer to yield the composite membrane.

### CROSS-REFERENCE TO RELATED APPLICATION

This application is a divisional of U.S. application Ser. No. 11/686,646 filed Mar. 15, 2007, now pending; which claims the benefit under 35 U.S.C. § 119(e) of U.S. Provisional Patent Application No. 60/782,833 filed Mar. 16, 2006; and U.S. Provisional Patent Application No. 60/809,506 filed May 31, 2006; all of these applications are incorporated herein by reference in their entireties.

### BACKGROUND

1. Technical Field

This invention generally relates to the fluorination of a porous hydrocarbon-based polymer for use as a composite membrane and, more particularly, for use as a composite proton exchange membrane of a fuel cell.

2. Description of the Related Art

In general terms, an electrochemical fuel cell converts a fuel (such as hydrogen or methanol) and oxygen into electricity and water. Fundamental components of fuel cells include two electrodes—the anode and cathode—separated by a proton exchange membrane (PEM). Each electrode is coated on one side with a thin layer of catalyst, with the PEM being “sandwiched” between the two electrodes and in contact with the catalyst layers. Alternatively, one or both sides of the PEM may be coated with a catalyst layer, and the catalyzed PEM is sandwiched between a pair of porous electrically conductive electrode substrates. The anode/PEM/cathode combination is referred to as a membrane electrode assembly or “MEA.” Hydrogen fuel dissociates into electrons and protons upon contact with the catalyst on the anode-side of the MEA. The protons migrate through the PEM, while the free electrons are conducted from the anode, in the form of usable electric current, through an external circuit to the cathode. Upon contact with the catalyst on the cathode-side of the MEA, oxygen, electrons from the external circuit, and protons that pass through the PEM combine to form water.

Desirable characteristics of a PEM include good mechanical properties, high conductivity, resistance to oxidative and thermal degradation, and dimensional stability upon hydration and dehydration. One example is a product sold by DuPont under the trade name Nafion®, a polytetrafluoroethylene-based ionomer containing sulfonic acid groups to provide proton conductivity. This material has been used effectively in PEM fuel cells due to its acceptable proton conductivity, as well as its mechanical and chemical characteristics.

Materials such as Nafion®, however, are quite expensive, and many attempts have been made to develop alternative materials. One such approach involves a composite material; namely, a woven or non-woven substrate interpenetrated with a proton-conducting polymer (also referred to as the ionomer). The resulting composite membrane generally exhibits the strength of the substrate, and the ion-conducting properties of the ionomer. A representative composite membrane is manufactured by W.L. Gore and Associates under the tradename Gore-Select®, and consists of a porous PTFE membrane impregnated with Nafion®.

While advances have been made in this field, there remains a need in the art for new and/or improved composite membranes generally and, more particularly, for membranes useful as a PEM of fuel cells, that avoid or minimize the drawbacks associated with existing materials used for this purpose. The present invention fulfills these needs, and provides further related advantages.

### BRIEF SUMMARY

In brief, this invention is directed to a fluorinated porous hydrocarbon-based polymer, and the loading of the same with an ionomer to yield a composite membrane, particularly in the context of a proton exchange membrane (PEM) for a fuel cell. Fluorination of the porous hydrocarbon-based polymer imparts enhanced oxidative stability thereto, yielding improved performance and/or durability upon subsequent loading with an ionomer.

In one embodiment, the composite membrane is formed by the fluorination of the porous hydrocarbon-based polymer such as, for example, polyethylene, followed by ionomer loading. Such porous hydrocarbon-based polymers may take a variety of forms, including but not limited to a porous film. The porous hydrocarbon-based polymer comprises numerous individual pores, and fluorination of the porous hydrocarbon-based polymer results in the fluorination of the available surfaces of the polymer, including surfaces within the individual pores.

In further embodiments, a membrane electrode assembly (MEA) is disclosed comprising the composite membrane of this invention, as well as fuel cells containing such an MEA.

These and other aspects of this invention will be evident upon reference to the following detailed description. To this end, a number of articles and patent documents are cited herein to aid in understanding certain aspects of this invention. Such documents are hereby incorporated by reference in their entirety.

### DETAILED DESCRIPTION

As noted above, this invention is directed to fluorination of a porous hydrocarbon-based polymer, and the loading of the same with an ionomer to yield a composite membrane. For purpose of brevity, the porous hydrocarbon-based polymer will sometimes be referred to herein as the “substrate”, while the fluorinated porous hydrocarbon-based polymer will sometimes be referred to as the “fluorinated substrate”. In this regard, a composite membrane is formed by loading the fluorinated substrate with an ionomer. The composite membrane thus exhibits the properties of the fluorinated substrate, including enhanced oxidative stability, and the ion-conducting properties of the ionomer.

As used herein, a “hydrocarbon-based polymer” means a hydrocarbon polymer that entirely, or to a significant degree, lacks halogen substituents, particularly fluorine. Thus, a hydrocarbon polymer having some minimal level of halogenation is still considered a hydrocarbon-based polymer in the context of this invention. Such a minimal level of halogenation is characterized herein by the frequency that hydrogen atoms of the hydrocarbon-based polymer have been replaced with halogen atoms. The hydrocarbon-based polymers of this invention may generally be characterized as having a branched or unbranched hydrocarbon backbone, and optionally contain pendent groups joined to the backbone. Thus, replacement of hydrogen atoms with halogen atoms can be at any location along the hydrocarbon polymer, including replacement on the backbone and/or the optional pendent groups.

In one specific embodiment, the hydrocarbon-based polymer bears no halogen substituents, and thus zero percent (0%) of the hydrogen atoms of the hydrocarbon-based polymer have been replaced with halogen atoms. In this context, representative materials may be any porous non-perfluorinated hydrocarbon-based polymer including, but are not limited to, polyethylene, polypropylene and polystryrene, as well as polyimides and polyurethanes. Generally, and with regard to polyethylene (PE) polymers, such PE polymers have molecular weights in excess of 200,000, and typically in excess of 1,000,000, such as from 1,000,000 up to 6,000,000, or in another embodiment from 3,100,000 up to 5,670,000. In further specific embodiments, the hydrocarbon polymer bears halogen atoms at the following frequencies: less than 10%, less than 20%, less than 30%, less than 40%, or less than 50%. Again, such percentages mean that, of the hydrogen atoms of the hydrocarbon-based polymer, less than the above percentage have been replaced with halogen atoms.

As used herein, a “porous” hydrocarbon-based polymer means a polymer having a porosity in excess of 50 volume percent (vol. %), generally in excess of 70 vol. %, 75 vol. %, or 80 vol. %, and typically in the range of 70-95 vol. %. Such polymers typically comprise a very open structure having micro-fibrillar and laminar networks, yielding what can be characterized as an interconnected pore network having mean flow pore sizes ranging from 0.05-1.0 μm.

The porous hydrocarbon-based polymer or substrate may be in a variety of different shapes and/or forms, largely depending upon its intended application. For example, in one embodiment, the substrate is in the form of a thin film having a thickness in the range of 10-120 μm, and in one embodiment in the range of 10-30 μm. In this regard, a suitable substrate is ultra high molecular weight porous polyethylene polymer film containing ultra high molecular weight polyethylene in an amount ranging from 1% to 100% by weight, wherein the remaining portion constitutes a polymer with similar glass transition and/or flow properties.

In one embodiment, the ultra high molecular weight polyethylene polymer film is a product sold under the tradename Solupor® 3P07A (DSM Solutech). This particular film has a thickness of 20 μm, porosity of 83 vol. %, air permeability (Gurley number) of 1.4 s/50 ml, and a mean flow pore size of 0.7 μm (DSM Solutech, Solupor® 3P07A Product Data Sheet).

Typically, fluorination of the substrate proceeds to a point such that substantially all of the hydrogen atoms of the porous hydrocarbon-based polymer are replaced with fluorine, yielding a perfluorinated substrate. As used herein, “substantially all” generally means that a perfluorinated polymer is generated. While it is possible that some small number of residual hydrogens are not replaced, such residual levels are typically very small. In this regard, the individual pores of the interconnected pore network of the substrate are also perfluorinated. The extent of fluorination necessary to yield a perfluorinated polymer (including the interconnected pore network) will depend upon the nature of the substrate employed. As discussed above, and in one embodiment, the substrate contains no halogen substituents, such as fluorine, while in other embodiments the substrate may contain some level of fluorination. Accordingly, more extensive fluorine transfer to the porous hydrocarbon-based polymer may be required when using a porous hydrocarbon-based polymer containing no fluorine substituents, compared to use of one that has some initial level of fluorination.

Fluorination of the substrate may be accomplished by any of a variety of known techniques. For example, the substrate may be contacted with fluorine gas, typically diluted with an inert gas and, optionally, with a small amount of other gases such as carbon dioxide to manipulate the surface of the substrate, at room temperature (see, e.g., Lagow and Margrave, “The Controlled Reaction of Hydrocarbon Polymers with Elemental Fluorine”, Polymer Letters Edition, Publ. John Wiley & Sons, Vol. 12, pp 177-184, 1974). Again, any number of fluorination techniques may be utilized, which techniques are well known to those skilled in this field.

Fluorination of the substrate, including the interconnected pore network thereof, greatly enhances the ability of the porous hydrocarbon-based polymer to resist oxidative degradation, thereby improving performance and/or durability. In contrast, existing perfluorinated membranes such as Nafion® are susceptible to oxidation due to the presence of residual non-fluorinated end groups that serve as sites for radical attack and lead to premature membrane failure. Fluorination of the porous hydrocarbon-based polymer provides a perfluorinated polymer lacking such susceptible sites, and thus is less susceptible to failure. In addition, fluorination of the pores themselves provide protection against radical attack and yields improved ionomer interaction upon ionomer loading.

Once formed, the fluorinated substrate is loaded with an ionomer, either by surface coating, by impregnation, or both. Such loading techniques are well known to one skilled in the field and include, for example, gravure coating, doctor coating, dipping, painting, roll-coating, spraying, brushing, or any impregnation method known in the art. To this end, representative ionomers include, but are not limited to, ion-exchange materials such as Nafion®, BAM®, Flemion®, Hyflon®, Aciplex®, PFSA resins, partially fluorinated sulfonic acid resins, sulfonated polyarylene ethers (PAEs), and sulfonated styrene-ethylene-butylene-styrenes (SEBS).

The fluorinated substrate is loaded with ionomer to a level sufficient to impart the desired level of ion-conductivity. Ion-conductivity may be measured by, for example, impedance spectroscopy as described by Gardner and Anantaraman (J. Electroanal. Chem. 395:67, 1995). For use as an electrolyte for a PEM fuel cell within the temperature range of 20° C. to 200° C., a desired level of ion-conductivity is in excess of 0.02 Ω⁻¹cm⁻¹, commonly in excess of 0.05 Ω⁻¹cm⁻¹, and typically in excess of 0.10 Ω⁻¹cm⁻¹.

As mentioned previously, the fluorinated substrate, and thus the corresponding composite, may be in a variety of different forms and/or shapes. In one embodiment, the fluorinated substrate is in the form of a sheet or a film, and the resulting composite membrane serves as an electrolyte in a fuel cell. In this embodiment, the composite membrane preferably conducts protons and is commonly referred to as a proton-exchange membrane, or PEM. In other embodiments, the PEM can be interposed between and bonded to electrode layers (e.g., the cathode and anode), the side of each electrode facing the PEM being in contact with a catalyst layer, such as, for example, a platinum, platinum alloy, supported platinum, or supported platinum alloy catalyst. The catalyst layer may be applied to the membrane or to the electrode surface. Such an assembly—that is, anode/PEM/cathode—is referred to as a membrane electrode assembly, or MEA. One method for forming the MEA involves spraying, or otherwise applying to the electrodes, a solution of ion-exchange material that is the same as, or different from, the ion-exchange material of the PEM. This ion-exchange material is typically applied to the catalyst-side of each electrode, with the PEM sandwiched between the two electrodes such that the side of the electrode to which the ion-exchange material has been applied is in contact with the PEM. A compressive force is then applied, typically in conjunction with heat, to form the MEA. In further embodiments, fuel cells are disclosed that incorporate such a PEM and/or MEA, and such fuel cells may be combined to form a fuel cell stack. In this regard, a variety of known techniques may be employed to make MEAs using the ion-exchange material of this invention.

The following example is provided for purpose of illustration, not limitation.

### EXAMPLE 1

### Fluorination of Porous Hydrocarbon-Based Polymer

A commercially available high molecular weight porous polyethylene polymer film containing ultra high molecular weight polyethylene (Solupor® 3P07A, DSM Solutech) is cut into a 200 cm×20 cm sheet. The sample film is then fluorinated by placing it in a sealed reactor, containing 25% fluorine and the balance nitrogen. The sample is treated for 25 minutes at ambient temperature and pressure to fluorinate the surface of the sample. A similarly sized control film is not fluorinated.

All of the above U.S. patents, U.S. patent application publications, U.S. patent applications, foreign patents, foreign patent applications and non-patent publications referred to in this specification and/or listed in the Application Data Sheet are incorporated herein by reference, in their entirety.

From the foregoing, it will be appreciated that, although specific embodiments of this invention have been described herein for the purpose of illustration, various modifications may be made without departing from the spirit and scope of the invention. Accordingly, the invention is not limited except by the appended claims.

1. A method for making a composite membrane, comprising fluorinating a porous hydrocarbon-based polymer to yield a fluorinated substrate, and loading the fluorinated substrate with ionomer to yield the composite membrane.

2. The method of claim 1 wherein the porous hydrocarbon-based polymer is polyethylene, polypropylene, polystyrene, polyimide or polyurethane.

3. The method of claim 1 wherein the porous hydrocarbon-based polymer has a molecular weight in excess of 1,000,000.

4. The method of claim 1 wherein the porous hydrocarbon-based polymer has a porosity in excess of 70 vol. %.

5. The method of claim 1 wherein the ionomer is Nafion®, BAM®, Flemion®, Hyflon®, Aciplex®, PFSA resins, partially fluorinated sulfonic acid resins, sulfonated polyarylene ethers (PAEs), and sulfonated styrene-ethylene-butylene-styrenes (SEBS).

6. The method of claim 1 wherein the ionomer is loaded by surface coating the fluorinated substrate with ionomer.

7. The method of claim 1 wherein the polymer is in the form of a film.

8. A composite membrane made by the method of claim 1.

9. A membrane electrode assembly comprising the composite membrane of claim 8.

10. A fuel cell comprising the membrane electrode assembly of claim 9.

11. A fuel cell stack comprising the fuel cell of claim 10.

12-15. (canceled)
